(19) United States
(12) Patent Application Publication
(10) Pub. No.: US 2006/0146214 A1
(43) Pub. Date: Jul. 6, 2006

(54) Thin film transistor substrate, method of manufacturing the same, liquid crystal display apparatus having the same and method of manufacturing the liquid crystal display apparatus

(76) Inventors: Seong-Yong Hwang, Gyeonggi-do (KR); Weon-Sik Oh, Gyeonggi-do (JP); Ju-Young Yoon, Gyeonggi-do (JP); Sung-Chul Kang, Gyeonggi-do (KR)

Correspondence Address: Frank Chau;F Chau & Associates, 130 Woodbury Road, Woodbury, NY, 11797, US

(21) Appl. No.: 10/534,983

(22) PCT Filed: Dec. 5, 2003
(86) PCT No.: PCT/KR03/02662

§ 371 Date: May 14, 2005

(30) Foreign Application Priority Data
Dec. 9, 2002 (KR) 10-2002-0078017

(51) Int. Cl. G02F 1/136

(52) U.S. Cl. 349/43

(57) ABSTRACT

A conductive bump including a plurality of protrusion members (251) and a conductive layer (252) formed on the protrusion members is disposed on a TFT substrate (200). Each of the protrusion members is disposed on an electrode pad (270y, b, 280c, b) in a pad region (292, 293) of the TFT substrate, and the conductive layer is electrically connected to the electrode pad. A non-conductive resin (600) is disposed on the conductive bump, and a driving IC (500) is thermally compressed on the conductive bump. Therefore, the electrical contact characteristic between the driving IC and the electrode pad is improved.

### TECHNICAL FIELD

The present disclosure relates to a thin film transistor (hereinafter, referred to as TFT) substrate, a method of manufacturing the same, a liquid crystal display (hereinafter, referred to as LCD) apparatus having the same and a method of manufacturing the LCD apparatus. More particularly, the present invention relates to a TFT substrate capable of improving electrical contact between a driving integrated circuit (IC) and an electrode pad, to a method of manufacturing the same, to an LCD apparatus having the TFT substrate, and to a method of manufacturing the LCD apparatus.

### BACKGROUND ART

FIG. 1 is a cross-sectional view illustrating a conventional chip-on-glass (COG) bonding structure between an LCD panel and a driving IC of an LCD apparatus.

Referring to FIG. 1, an electrode pad 12 in a pad region of an LCD panel 10 is electrically connected to an electrode of a driving IC 20 by an anisotropic conductive layer 30.

A plurality of electrode pads 12 is arranged in the pad region defined on an insulating substrate 11, and each of the electrode pads 12 is separated from one another spaced apart by a predetermined distance. The electrode pads 12 are electrically connected to the driving IC to receive a driving signal for driving the LCD panel 10.

As an exemplarily embodiment, the anisotropic conductive film (ACF) 30 includes a thermosetting resin including a plurality of conductive balls 31. The conductive balls 31 are disposed between the electrode pad 12 and the electrode 21 of the driving IC 20, and as a result, the electrode pad 12 and the driving IC 20 can make electrically contact with each other. In addition, the ACF 30 allows the driving IC 20 to adhere to the electrode pad 12, so that the electrical contact between the electrode pad 12 and the driving IC 20 can be guaranteed or maintained.

Hereinafter, the conventional COG bonding process for electrically connecting the electrode pad 12 and the driving IC 20 using the ACF 30 is schematically introduced.

At first, the ACF 30 is positioned on each of the electrode pads 12, and then, the driving IC 20 is positioned such that the electrodes 21 thereof corresponds to each of the electrode pads 12 one to one. Subsequently, the driving IC 20 is thermally pressed down on the electrode pad 12. Accordingly, the conductive balls 31 are compressed between the electrode pad 12 and the electrode 21 of the driving IC 20, and thus the electrode pad 12 makes electrical contact with the driving IC 20. The ACF 30 is softened by the thermo-compression process, and has been gradually hardened from the time when the thermo-compression process is completed. The driving IC 20 firmly adheres to the electrode pad 12 due to the hardening of the ACF 30, so that the driving IC 20 makes good contact with the electrode pad 12 through the intermediary of the conductive balls 31.

### DISCLOSURE OF THE INVENTION

The COG bonding structure is not cheap in that the ACF 30 is expensive, and thus the manufacturing cost of the LCD apparatus is increased.

Furthermore, the COG bonding structure also has misalignment between the driving IC 20 and the electrode pad 12 and short circuit. The misalignment causes a transfer failure of the driving signal from the driving IC 20 to the electrode pad 12.

In general, all the spaces between the electrode pads or between the electrodes of the driving IC 20 are not completely uniform or constant, so the conductive ball 31 of the ACF 30 may not be positioned between the electrode of the driving IC 20 and the electrode pad 12 during the thermal compression of the driving IC 20. Accordingly, the driving IC 20 could not be electrically connected with the corresponding electrode pad 12 due to the absence of the conductive ball 31, so that the driving signal for driving an LCD panel would not be transferred to the electrode pad 12 from the driving IC 20.

Meanwhile, the conductive balls 31 excessively may gather around between the driving IC 20 and the electrode pad 12, so that an excessive current could be applied between the driving IC 20 and the electrode pad 12. That is, a short circuit may be caused due to an excessive accumulation of the conductive balls between the electrode pad 12 and the driving IC 20.

The present invention provides a TFT substrate capable of improving electrical contact between a driving IC and an electrode pad in a pad region thereof.

The present invention also provides a method of manufacturing the TFT substrate.

The present invention also provides an LCD apparatus having the TFT substrate.

The present invention also provides a method of manufacturing the LCD apparatus.

The TFT substrate in accordance with one exemplary embodiment of the present invention includes a plurality of electrode pads and a conductive bump. The electrode pads are formed on end portions of gate and data lines arranged on a substrate. The conductive bump includes a protrusion member and a conductive coating layer. The conductive bump is electrically connected to a driving IC that applies a predetermined signal to the electrode pads by using a non-conductive resin. The protrusion member having a predetermined thickness is disposed on the electrode pad. The conductive coating layer electrically connected to the electrode pad is disposed on the protrusion member.

The protrusion member comprises an elastic organic material. The protrusion member may include a plurality of projections that are spaced apart by a predetermined distance, and is disposed on the electrode pad such that a portion of the electrode pad is exposed through a space between the projections or a peripheral portion of the electrode pad is exposed. The protrusion member includes an embossing pattern on an upper surface thereof.

The method of manufacturing the TFT substrate in accordance with one aspect of the present invention comprises forming a gate line, a data line and a plurality of electrode pads, and forming a conductive bump. The plurality of electrode pads is formed on end portions of the gate and data lines on a substrate. The conductive bump is formed on the electrode pad, and is electrically connected to a driving IC for applying a predetermined signal to the electrode pad by using a non-conductive resin. The conductive bump includes a protrusion member and a conductive coating layer. The non-conductive resin is disposed between the conductive bump and the driving IC. The protrusion member having a predetermined thickness is formed on the electrode pad. The conductive coating layer electrically connected to the electrode pad is formed on the protrusion member.

The method of manufacturing the TFT substrate in accordance with another aspect of the present invention includes forming a photoresist organic layer, patterning the photoresist organic layer, forming a conductive layer, and patterning the conductive layer. As an exemplary embodiment, the photoresist organic layer is coated on the pixel and pad regions, and then is patterned to thereby form an insulating film on the pixel region and a protrusion member on the pad region. The insulating layer protects the plurality of TFTs and the conductive lines, and the protrusion member is formed on the electrode pad. The conductive layer is deposited and patterned on the insulating layer and the protrusion member, so that a pixel electrode is formed on the insulating layer and a conductive coating layer is formed on the protrusion member.

The LCD apparatus in accordance with one aspect of the present invention, which includes a pixel region having a plurality of TFTs and conductive lines connected to the TFTs, and a pad region having a plurality of electrode pads, comprises an LCD panel, a driving IC and an adhering member. The LCD panel includes a TFT substrate, a color filter substrate facing the TFT substrate, and a liquid crystal layer interposed between the TFT substrate and the color filter substrate. The TFT substrate includes a protrusion member and a conductive bump. The protrusion member is disposed on the electrode pad, and the conductive bump is disposed on the protrusion member. The conductive bump includes a conductive coating layer electrically connected to the electrode pad.

The driving IC is electrically connected to the conductive bump, and applies a predetermined signal to the electrode pad.

The adhering member is disposed between the conductive bump and the driving IC, and adheres the driving IC to the conductive member to ensure an electrical connection between the conductive bump and the driving IC.

The protrusion member comprises an elastic organic material. The protrusion member may include a plurality of projections spaced apart by a predetermined distance, and is disposed on the electrode pad such that a portion of the electrode pad is exposed through a space between the projections or a peripheral portion of the electrode pad is exposed. The protrusion member includes an embossing pattern on an upper surface thereof.

The adhering member is a non-conductive resin that is softened during a thermal compression process on the driving IC, and has gradually hardened from the time when the thermal compression process is completed. Therefore, the driving IC is adhered to the conductive bump by using a contraction of the driving IC during a hardening of the driving IC.

The method of manufacturing the LCD apparatus in accordance with one exemplary embodiment of the present invention, which includes a pixel region having a plurality of TFTs and conductive lines connected to the TFTs, and a pad region having a plurality of electrode pads, is manufactured by performing the steps of forming a TFT substrate including a protrusion member and a conductive member, forming a color filter substrate, forming a liquid crystal layer, and connecting a driving IC to the conductive bump. The protrusion member is formed on the electrode pad. The conductive bump is formed on the protrusion member, and has a conductive coating layer that is electrically connected to the electrode pad. The color filter substrate is oppositely combined with the TFT substrate. The liquid crystal layer is interposed between the TFT substrate and the color filter substrate. The driving IC for applying a predetermined signal to the electrode pad is electrically connected to the conductive bump b using an adhering member.

The conductive layer comprises indium tin oxide (ITO), indium zinc oxide (IZO), or metal. The conductive layer may include a stacked layer having first and second layers. The first layer comprises ITO or IZO, and the second layer comprises metal.

The insulating layer includes an organic insulating layer or an inorganic insulating layer. Preferably, the insulating layer may include the organic insulating layer.

With the above exemplary embodiments, an elastic conductive bump is disposed on each of the electrode pads while the driving IC is mounted on the pad region of the TFT substrate, and a non-conductive resin is interposed between the driving IC and the conductive bump for electrically connecting the driving IC to the conductive bump. Therefore, the electrical contact characteristic between the driving IC and the electrode pad is improved.

### BRIEF DESCRIPTION OF THE DRAWINGS

The above and other advantages of the present invention will become readily apparent by reference to the following detailed description when considered in conjunction with the accompanying drawings wherein:

FIG. 1 is a cross-sectional view illustrating a conventional chip-on-glass (COG) bonding structure between an LCD panel and a driving IC of an LCD apparatus.

FIG. 2 is a plan view illustrating an LCD apparatus according to one exemplary embodiment of the present invention;

FIG. 3 is a cross-sectional view taken along a line I-I′ of FIG. 2;

FIG. 4 is a plan view illustrating a TFT substrate of FIG. 2;

FIG. 5 is a cross-sectional view taken along a line II-II′ of FIG. 4;

FIG. 6 is a partially enlarged view illustrating a part of a conductive bump of FIG. 5;

FIG. 7 is a cross-sectional view illustrating a bonding structure between a conductive bump and a driving IC according to one exemplary embodiment of the present invention;

FIGS. 8A and 8B are cross-sectional views illustrating a gate pad region and a data pad region according to one exemplary embodiment of the present invention;

FIGS. 9A and 9B are cross-sectional views illustrating a gate pad region and a data pad region according to one exemplary embodiment of the present invention;

FIGS. 10A to 10D are cross-sectional views illustrating a method of manufacturing a TFT substrate according to one exemplary embodiment of the present invention;

FIGS. 11A and 11B are cross-sectional views illustrating a method of manufacturing a TFT substrate according to one exemplary embodiment of the present invention; and

FIGS. 12A and 12B are cross-sectional views illustrating a method of manufacturing a TFT substrate according to one exemplary embodiment of the present invention.

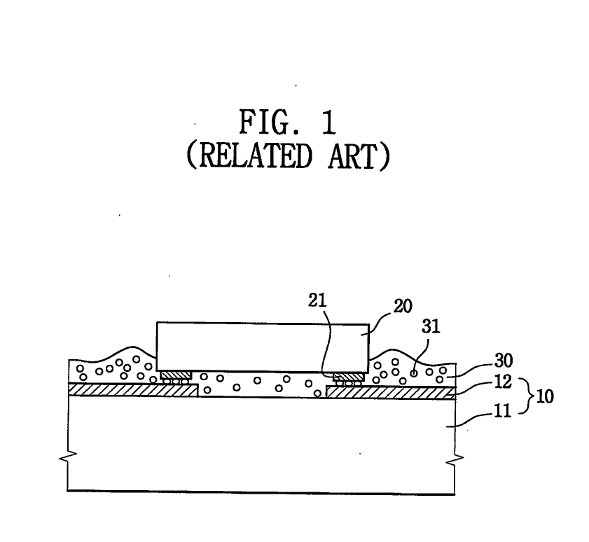

### BEST MODE FOR CARRYING OUT THE INVENTION

The present invention now will be described more fully hereinafter with reference to the accompanying drawings, in which exemplary embodiments of the present invention are shown. This invention may, however, be embodied in many different forms and should not be construed as limited to the embodiments set forth herein.

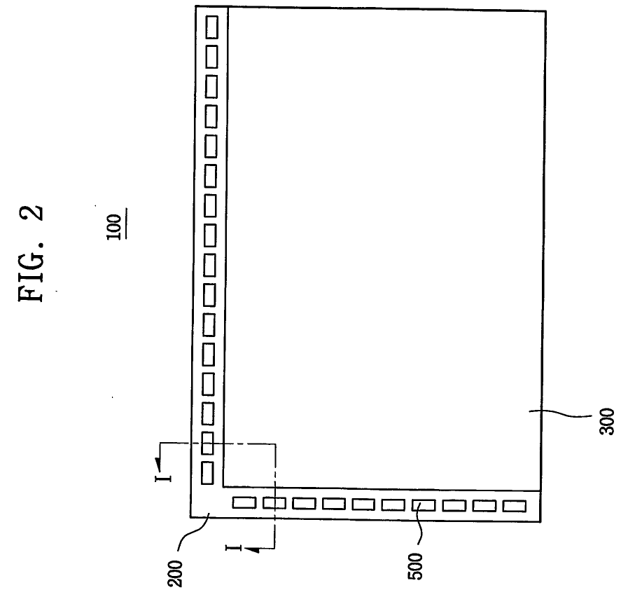

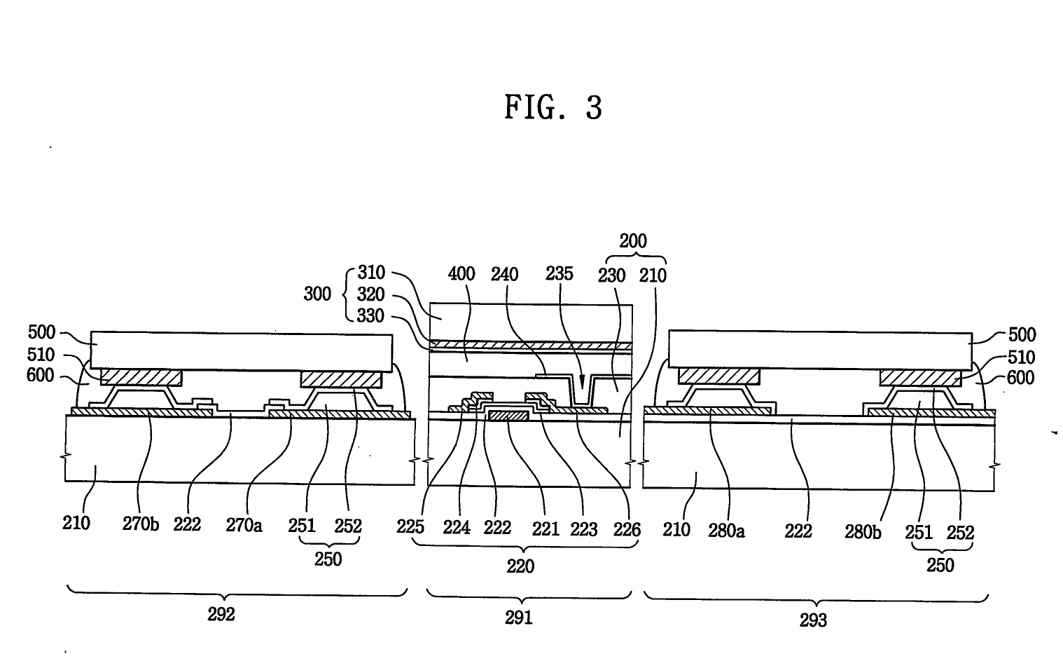

FIG. 2 is a plan view illustrating an LCD apparatus according to a first exemplary embodiment of the present invention, and FIG. 3 is a cross-sectional view taken along a line I-I′ of FIG. 2.

Referring to FIGS. 2 and 3, the LCD apparatus 100 according to the first embodiment of the present invention includes an LCD panel having a TFT substrate 200, a color filter substrate 300 and a liquid crystal layer 400 disposed between the TFT substrate 200 and the color filter substrate 300.

The LCD panel includes a pixel region 291 in which the color filter substrate is overlapped with the TFT substrate, and pad regions 292 and 293 in which the color filter substrate is not overlapped with the TFT substrate.

The pad regions include a gate pad region 292 for applying a gate signal to the pixel region 291, and a data pad region 293 for applying a data signal to the pixel region 291.

Therefore, as shown in FIG. 3, the pixel region includes the TFT substrate 200, the color filter substrate 300 corresponding to the TFT substrate 200, and the liquid crystal layer 400 interposed between the TFT substrate 200 and the color filter substrate 300, so that an image is displayed in the pixel region 291.

The TFT substrate 300 includes a first insulating substrate 210, a plurality of TFTs 220 disposed on the first substrate 210, an organic or inorganic insulating layer 230, and a pixel electrode 240. The insulating layer 230 is disposed on each of the TFTs 220 with a predetermined thickness. The pixel electrode 240 is disposed on the insulating layer 230 with a uniform thickness.

The TFT 220 includes a gate electrode 221 branched from a gate line (not shown) extending in a first direction on the first insulating substrate 210, a gate insulating layer 222 disposed on the gate electrode 221, semiconductor and ohmic contact layers 223 and 224 sequentially stacked on gate insulating layer 222 corresponding to the gate electrode 221, and source and drain electrodes 225 and 226 branched from a data line (not shown) extending in a second direction perpendicular to the first direction on the first insulating substrate 210.

The pixel electrode 240 is a transparent or reflective conductive layer having a material such as ITO and IZO, a metal layer or a combination of them. The conductive layer is also a stacked layer in which the transparent conductive layer and the metal layer are alternatively stacked.

A contact hole 235 is formed on the insulating layer 230 for exposing a portion of the drain electrode 226, and thus the pixel electrode 240 is electrically connected to the drain electrode 226 through the contact hole 235.

The color filter substrate 300 includes a second insulating substrate 310, a color filter layer 320 disposed on the second insulating layer 310 and a common electrode 330 disposed on the color filter layer 320. The color filter layer 320 includes red, green and blue color filters. The common electrode 330 is disposed on the color filter layer 320 with a uniform thickness.

The gate pad region 292 includes gate electrode pads 270a and 270b disposed on the first insulating substrate 210, a plurality of first conductive bumps 250 disposed on the gate electrode pads 270a and 270b, the driving IC 500 electrically connected to the first conductive bumps 250, and a non-conductive resin 600 for adhering the driving IC to the first conductive bumps 250 so as to ensure the electrical connection between the driving IC and the first conductive bumps 250. Each of the first conductive bumps 250 includes a first protrusion member 251 and a first conductive coating layer 252.

The data pad region 293 includes data electrode pads 280a and 280b on the first insulating substrate 210, a plurality of the first conductive bumps 250 disposed on the data electrode pads 280a and 280b, the driving IC 500 electrically connected to the first conductive bumps 250, and the non-conductive resin 600 for adhering the driving IC to the first conductive bumps 250 so as to ensure the electrical connection between the driving IC and the first conductive bumps 250. Each of the first conductive bumps 250 includes a first protrusion member 251 and a first conductive coating layer 252.

The driving IC 500 includes a plurality of electrodes 510 electrically connected to the first conductive bumps 250. Each of the electrodes 510 corresponds to the first conductive bump 250 one to one, and is electrically connected to the first conductive bump 250.

The driving IC 500 is mounted on the gate and data pad regions 292 and 293 through a thermal compression process or other proper methods. The non-conductive resin 600 is softened during the thermal compression process on the driving IC, and has gradually hardened from the time when the thermal compression process is completed. Therefore, the driving IC 500 is adhered to the first conductive bumps 250 after a lapse of predetermined time by a contraction of the non-conductive resin 600 due to the hardening thereof. That is, the electrodes of the driving IC 500 are firmly adhered to the first conductive bumps 250, so that the electrical connection between the first conductive bumps and the driving IC 500 can be ensured.

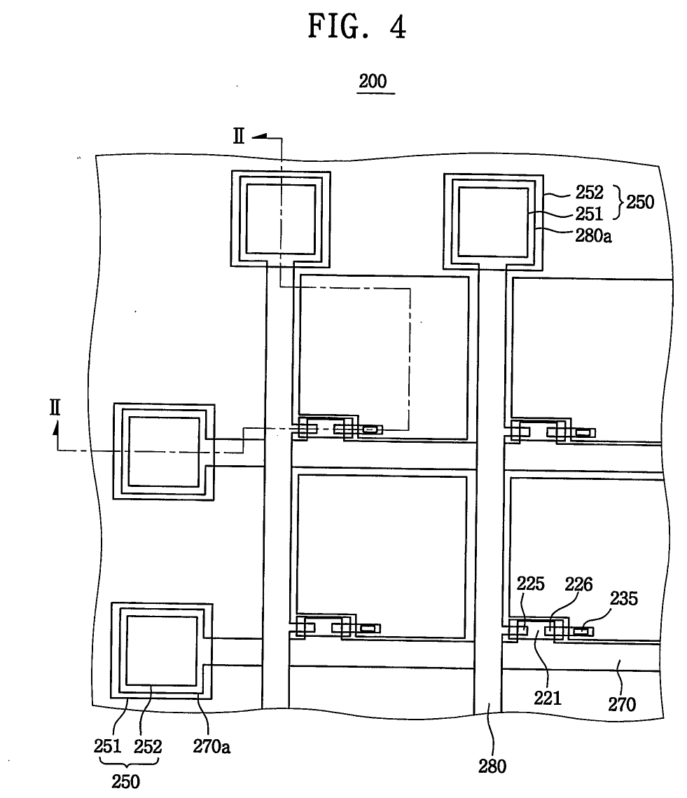

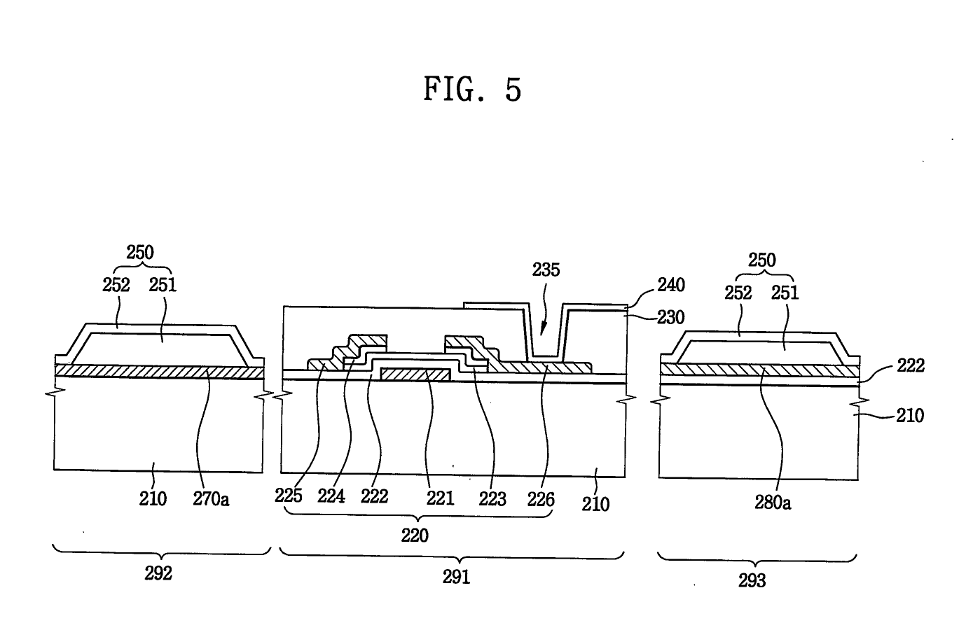

FIG. 4 is a plan view illustrating a TFT substrate of FIG. 2, and FIG. 5 is a cross-sectional view taken along a line II-II′ of FIG. 4. Referring now in specific detail to FIGS. 4 and 5 in which the same reference numerals denote the same elements in FIGS. 2 and 3, and thus any further detailed descriptions concerning the same elements will be omitted except a pixel region 291 of the LCD apparatus 100, a gate pad region 292 and a data pad region 293.

Referring to FIGS. 4 and 5, the TFT substrate 200 includes a plurality of gate and data lines 270 and 280, and a plurality of TFTs 220. The gate lines 270 extends in the first direction, and the data lines 280 extends in the second direction, so that the gate and data lines 270 and 280 cross each other to thereby be arranged in a matrix shape. Each of the TFTs 220 is disposed at a cross region of the gate and data lines 270 and 280. Each of the TFTs 220 includes the gate electrode 221 branched from the gate line 270, and the source and drain electrodes 225 and 226 branched from the data line 280. A gate electrode pad 270a is formed on an end portion of each of the gate lines 270, and a data electrode pad 280a is formed on an end portion of each of the data lines 280. Therefore, the TFT substrate 200 is divided into a pixel region 291 for displaying an image, a gate pad region 292 on which the gate electrode pad 270a is disposed, and a data pad region 293 on which the data electrode pad 280a is disposed. The gate and data pad regions are formed in a peripheral portion of the pixel region 291.

The gate electrode pads 270a and a plurality of first conductive bumps 250 are formed on the gate pad region 292. Each of the first conductive bumps 250 includes a first protrusion member 251 disposed on the gate electrode pad 270a with a predetermined depth and a first conductive coating layer 252 disposed on the first protrusion member 251. The first conductive coating layer 252 is electrically connected to the gate electrode pad 270a.

The gate insulating layer 222, the data electrode pads 280a and a plurality of the first conductive bumps 250 are formed on the data pad region 293. Each of the first conductive bumps 250 includes a first protrusion member 251 disposed on the data electrode pad 280a with a predetermined thickness, and a first conductive coating layer 252 disposed on the first protrusion member 251. The first conductive coating layer 252 is electrically connected to the data electrode pad 280a.

The gate and data electrode pads 270a and 280a are disposed on an end portion of the gate and data lines 270 and 280, respectively. In addition, the gate and data electrode pads 270a and 280a are wider than the gate and data lines 270 and 280, respectively.

The first protrusion member 251 on the gate electrode pad 270a or the data electrode pad 280a includes substantially the same material of the insulating layer 230 as is deposited on the TFTs 220 in the pixel region 291. The first conductive coating layer 252 disposed on the first protrusion member 251 includes substantially the same material of a pixel electrode layer as is deposited on the insulating layer 230 corresponding to the pixel region 291.

Therefore, the first conductive coating layer 252 is a transparent conductive layer when the pixel electrode 240 is formed with the transparent conductive layer having ITO or IZO, and the first conductive coating layer 252 is a metal layer when the pixel electrode 240 is formed with the metal layer. In addition, the first conductive coating layer 252 may be a transparent conductive layer, a metal layer or a stacked layer of the transparent conductive and metal layers when the pixel electrode 240 is formed with the stacked layer of the transparent conductive and metal layers.

The TFT substrate including the conductive bump 250 is installed to a liquid crystal display apparatus. The TFT substrate including the conductive bump 250 shown in FIGS. 4 and 5 may be installed to another flat display apparatus, for example, such as an organic electro-luminescent display apparatus, as would be known to a person having ordinary skill in the art.

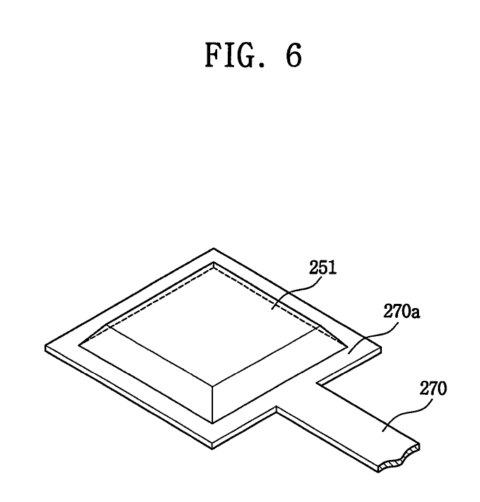

FIG. 6 is a partially enlarged view illustrating a part of a conductive bump of FIG. 5.

Referring to FIGS. 5 and 6, the first conductive bump 250 in the gate pad region 292 includes the first protrusion member 251 and the first conductive coating layer 252 disposed on the first protrusion member 251.

The first protrusion member 251 is disposed on the gate electrode pad 270a formed at an end portion of the gate line 270 with a predetermined thickness. The width of the first protrusion member 251 is smaller than the width of the gate electrode pad 270a, and the bottom surface area of the first protrusion members 251 is also smaller than the surface area of the gate electrode pad 270a, so that a peripheral portion of the gate electrode pad 270a is exposed. The conductive coating layer 252 is formed on the first protrusion members 251, and is electrically connected to the exposed peripheral portion of the gate electrode pad 270a.

In the same way of the first conductive bump on the gate pad region 292, the first conductive bump 250 on the gate pad region 293 includes a first protrusion member 251 and the first conductive coating layer 252 disposed on the first protrusion member 251. The first protrusion member is disposed on the data electrode pad 280a with a surface area smaller than the surface area of the data electrode pad 280a, so that the peripheral portion of the data electrode pad 280a is exposed. The first conductive coating layer 252 is formed on the first protrusion member 251, and is electrically connected to the peripheral portion of the data electrode pad 280a.

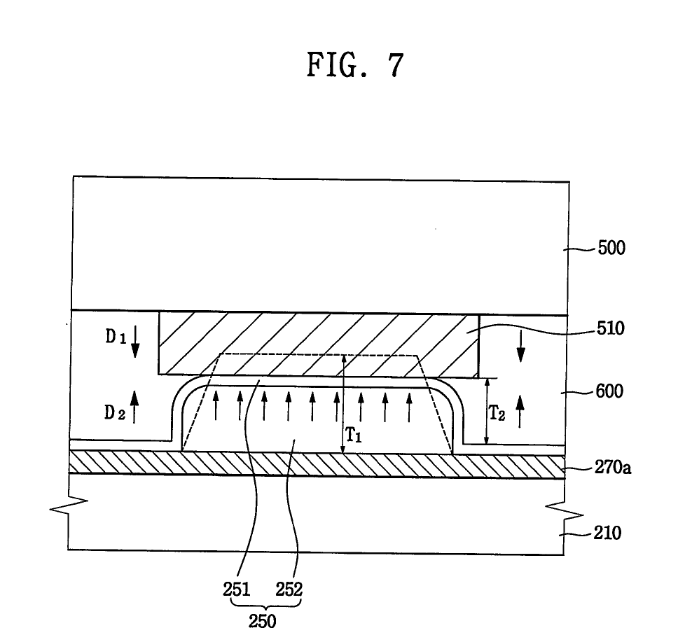

FIG. 7 is a cross-sectional view illustrating a bonding structure between a conductive bump and a driving IC according to a first embodiment of the present invention.

Referring to FIG. 7, the driving IC 500 is electrically connected to the first conductive bump 250 through an intermediary of a non-conductive resin 600 interposed between the first conductive bump 250 and the driving IC 500.

The first conductive bump 250 is formed on the gate electrode pad 270a with a first thickness (T1), and then is thermally compressed together with the driving IC 500, so that the conductive bump 250 is electrically connected to the driving IC 500. Since the first protrusion member 251 of the first conductive bump 250 comprises an elastic organic insulating material, the first conductive bump 250 is compressed to a second thickness (T2) during the thermal compression process.

As an exemplary embodiment of an adhering member for adhering the driving IC 500 to the first conductive bump 250, a non-conductive resin 600 is interposed between the first conductive bump 250 and the electrode 510 of the driving IC 500, so that the driving IC 500 is adhered to the first conductive bump 250, and as a result, the electrical connection between the driving IC 500 and the first conductive bump 250 is sufficiently ensured.

While the thermal compression process is performed, the non-conductive resin 600 is softened, and a portion of the non-conductive resin interposed between the electrode 510 and the first conductive bump 250 is extruded outwardly to a space neighboring the conductive bump 250 and the electrode 510. The non-conductive resin 600 has gradually hardened from the time when the thermal compression process is completed, so that the non-conductive resin 600 is contracted and finally is hardened into a predetermined shape. Accordingly, the first conductive bump 250 remains compressed to the second thickness T2, and thus is electrically connected to the electrode 510 of the driving IC 500.

When the non-conductive resin 600 is hardened, the non-conductive resin 600 is contracted in a first direction D1 and a second direction D2, so that the adhering force between the driving IC 500 and the first conductive bump 250 is reinforced by the contraction of the non-conductive resin 600.

According to the conventional bonding structure, the resistive heat generated between the first conductive bump and the driving IC increases the temperature of the non-conductive resin, and thus the non-conductive resin is thermally expanded. Accordingly, the distance between the gate electrode pad and the driving IC is widened due to the thermal expansion of the non-conductive resin, so that the electrical connection between the gate electrode pad and the driving IC is broken. The above-described bonding structure of the present invention can ensure the electrical connection between the gate electrode pad and the driving IC even though the non-conductive resin 600 is thermally expanded. The first conductive bump 250 comprises an elastic material, and the driving IC 500 is compressively bonded to the conductive bump 250 with the compressed thickness T2. Therefore, the restoring of the first conductive bump 250 can compensate for the increased distance between the gate electrode pad 270a and the driving IC 500 due to the thermal expansion of the non-conductive resin 600, so that the electrical connection between the gate electrode pad 270a and the driving IC 500 can be sufficiently ensured.

Besides the thermal expansion of the non-conductive resin 600, many other factors, for example, such as an impact on the boundary surface between the first conductive bump 250 and the driving IC, and a weakened adhering force of the non-conductive resin to the first conductive bump 250 and the driving IC 500, can also increase the distance between the gate electrode pad 270a and the driving IC 500. The first conductive bump 250 can also be restored corresponding to the increased distance due to the above other factors, so that the electrical connection between the gate electrode pad 270a and the driving IC 500 can also be sufficiently ensured.

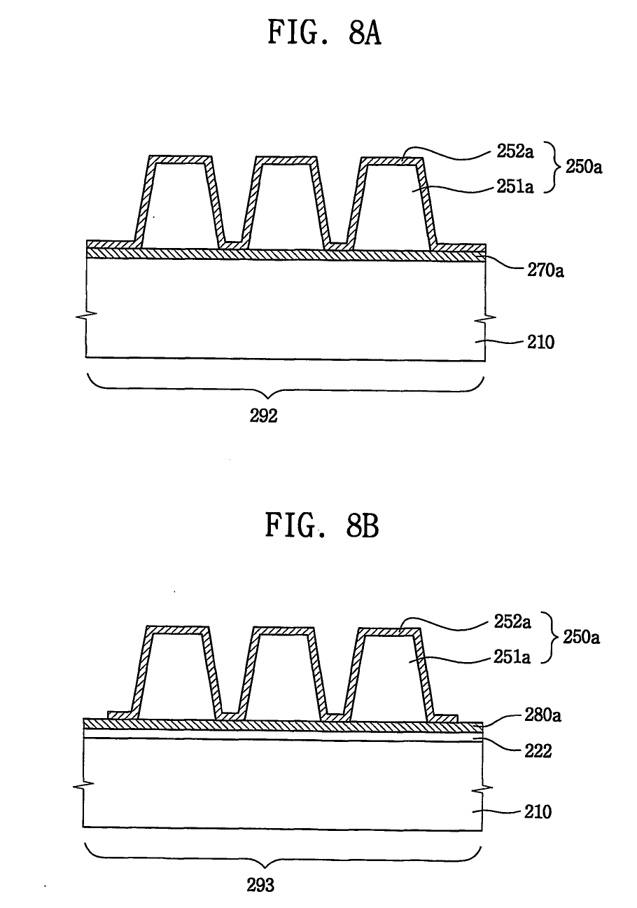

FIGS. 8A and 8B are cross-sectional views illustrating a gate pad region and a data pad region according to another embodiment of the present invention. Referring now in specific detail to FIGS. 8A and 8B in which the same reference numerals denote the same elements in FIGS. 2 and 3, and thus any further detailed descriptions concerning the same elements will be omitted.

Referring to FIG. 8A, the gate pad region 292 according to another embodiment of the present invention includes a first substrate 210, a gate electrode pad 270a disposed on the first substrate 210, and a plurality of second conductive bumps 250a. Each of the second conductive bumps 250a includes a second protrusion member 251a disposed on the gate electrode pad 270a and a second conductive coating layer 252a disposed on the second protrusion member 251a.

The gate electrode pad 270a is disposed on an end portion of the gate line 270 in the first substrate 210 with a predetermined surface area, as shown in FIG. 4.

A plurality of the second protrusion members 251a is disposed on the gate electrode pad 270a spaced apart by a predetermined distance. Therefore, the second protrusion members 251a are represented into a plurality of dots positioned on the gate electrode pad 270a when the gate electrode pad 270a including the second protrusion members 251a is viewed in a plan view thereof.

A portion of the gate electrode pad 270a is exposed through a space between the second protrusion members 251a, and the exposed portion of the gate electrode pad 270a is electrically connected to the second conductive coating layer 252a.

Referring to FIG. 8B, the data pad region 293 according to the another embodiment of the present invention includes a gate insulating layer 222 formed on the first substrate 210, a data electrode pad 280a disposed on the gate insulating layer 222, and a plurality of second conductive bumps 250a. Each of the second conductive bumps 250a includes a second protrusion member 251a disposed on the gate electrode pad 270a and a second conductive coating layer 252a disposed on the second protrusion member 251a.

The data electrode pad 280a is disposed on an end portion of the data line 280 on the insulating layer 222 with a predetermined surface area in a similar way of the above gate electrode pad 270a.

Since the second conductive bumps 250a on the data electrode pad 280a are substantially identical to the second conductive bumps 250a on the gate electrode pad 270a, hereinafter any further detailed descriptions concerning the second conducting bumps 250a on the data electrode pads 280a will be omitted.

The second conductive coating layer 252a may be a transparent conductive layer, a metal layer or a stacked layer of the transparent conductive and metal layers like the first conductive coating layer 252 shown in FIG. 5, and is electrically connected to the gate and data electrode pads 270a and 280a.

Each of the second conductive bumps 250a includes projections protruded from the gate and data electrode pads 270a and 280a, and comprises an elastic material. Each of the projections can be individually compressed to have different height with each other. Even though the electrodes of the driving IC are not uniform with each other, each projection of the second conductive bumps 250a is compressed to have different height according to a thickness of each electrodes of the driving IC, so that the second conductive bumps 250a are compressed to a different thickness, respectively. Therefore, the electrical connection between the driving IC and the second conductive bump can be stably guaranteed in spite of the non-uniformity of the electrodes of the driving IC.

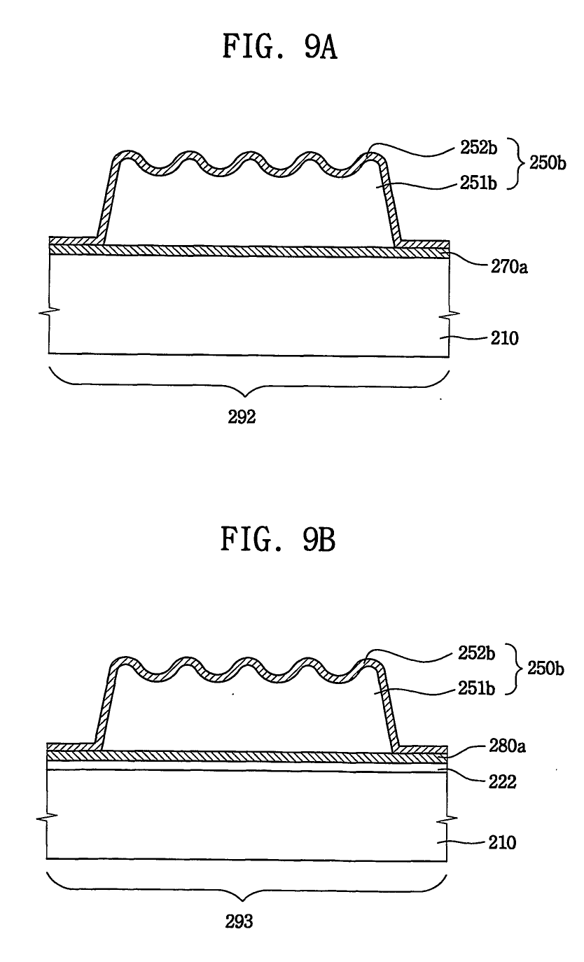

FIGS. 9A and 9B are cross-sectional views illustrating a gate pad region and a data pad region according to an further embodiment of the present invention.

Referring now in specific detail to FIGS. 9A and 9B in which the same reference numerals denote the same elements in FIGS. 8A and 8B, and thus any further detailed descriptions concerning the same elements will be omitted. Even though a gate electrode pad and a conductive bump thereon are exemplary shown in FIG. 9A, a plurality of gate electrode pads and conductive bumps may be disposed on a substrate. In the same way, even though a data electrode pad and a conductive bump thereon are exemplary shown in FIG. 9B, a plurality of data electrode pads and conductive bumps may be also disposed on a substrate.

Referring to FIG. 9A, the gate pad region 292 includes a first substrate 210, a gate electrode pad 270a disposed on the first substrate 210, and a third conductive bump 250b. The third conductive bump 250b includes a third protrusion member 251b disposed on the gate electrode pad 270a and a third conductive coating layer 252b disposed on the third protrusion member 251b.

An embossing pattern having a plurality of recessed portions and a plurality of protruded portions is formed on an upper surface of the third protrusion member 251b. The third conductive coating layer 252b is formed on the third protrusion member 251b in accordance with the shape of the embossing pattern and on the gate electrode pad 270a with a uniform thickness, so that the third conductive coating layer 252b is connected to an exposed portion of the gate electrode pad 270a neighboring side surface of the third protrusion member 251b.

Referring to FIG. 9B, the data pad region 293 includes a gate insulating layer 222 formed on the first substrate 210, a data electrode pad 280a disposed on the gate insulating layer 222, and a third conductive bump 250b. The third conductive bump 250b includes a third protrusion member 251b disposed on the data electrode pad 280a and a third conductive coating layer 252b disposed on the third protrusion member 251b.

Since the third conductive bump 250a on the data electrode pad 280a is substantially identical to the third conductive bump 250a on the gate electrode pad 270a, hereinafter any further detailed descriptions concerning the third conducting bump 250a on the data electrode pad 280a is omitted.

The third conductive coating layer 252b may be a transparent conductive layer, a metal layer or a stacked layer of the transparent conductive and metal layers like the first conductive coating layer 252 shown in FIG. 5, and is electrically connected to the gate and data electrode pads 270a and 280a.

When the driving IC is mounted on the above-mentioned third conductive bump, the protruded portion of the embossing pattern makes contact with the electrodes of the driving IC. Therefore, the electrical connection between the driving IC and the second conductive bump can be stably guaranteed even though the electrodes of the driving IC are not uniform in thickness.

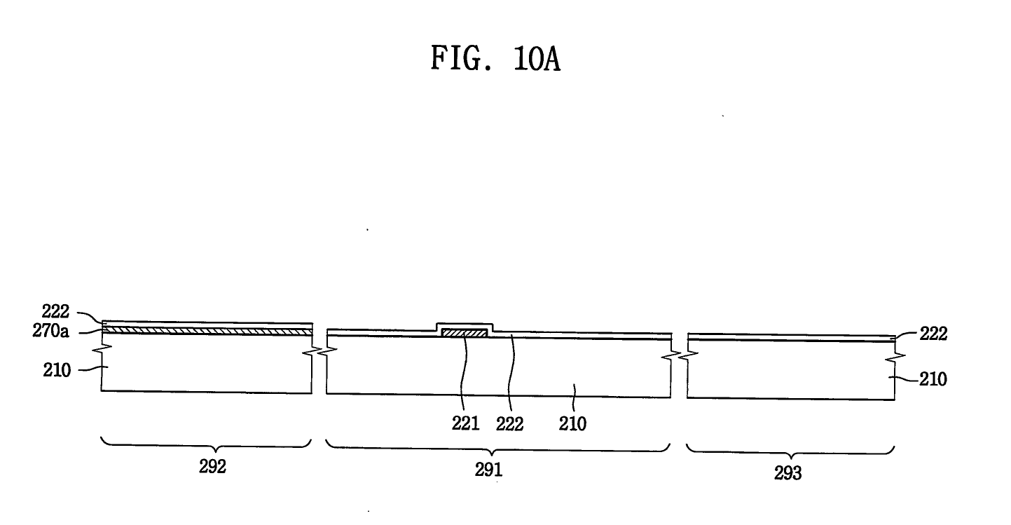

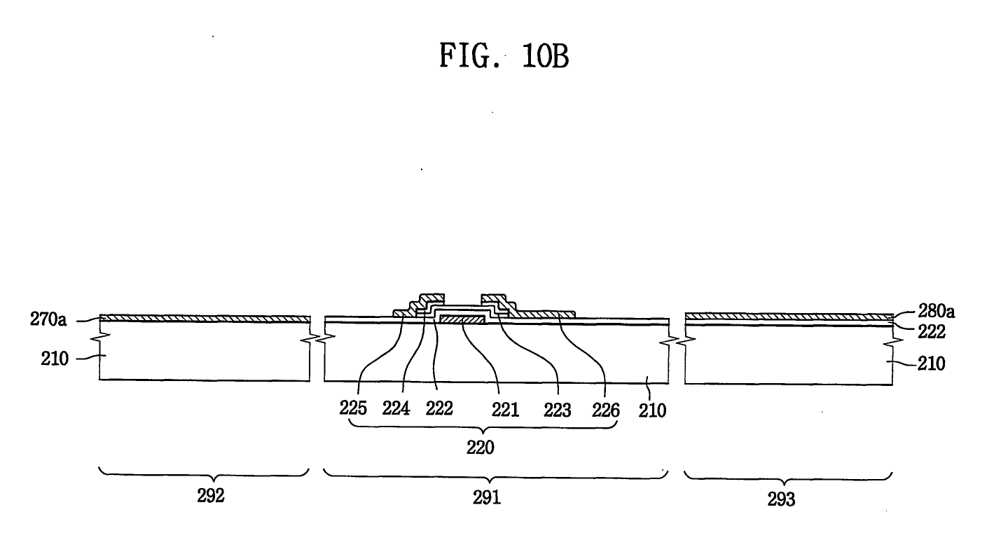

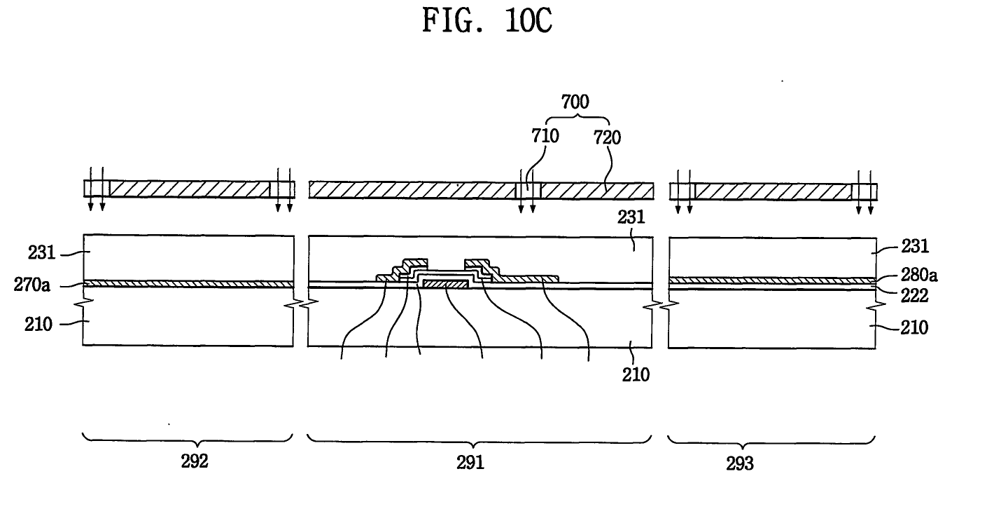

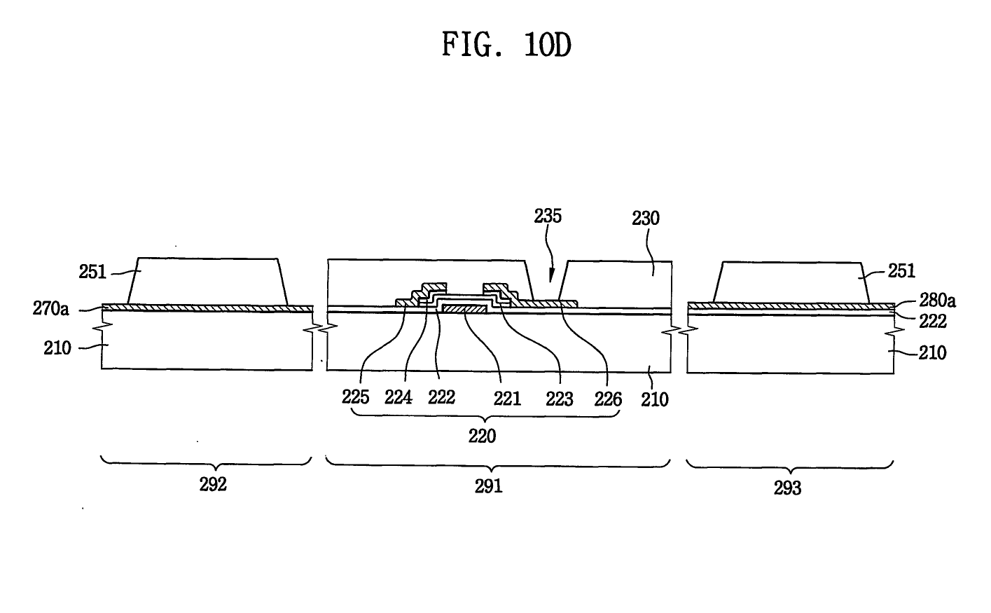

FIGS. 10A to 10D are cross-sectional views illustrating a method of manufacturing a TFT substrate according to an embodiment of the present invention.

Referring to FIGS. 4 and 10A, a first metal layer comprising a metal, for example, such as aluminum (Al), molybdenum (Mo), chrome (Cr), tantalum (Ta), titanium (Ti), copper (Cu), tungsten (W), etc., is deposited on the first substrate 210 comprising an insulating material such as glass, ceramic, etc.

The first substrate 210 includes a pixel region 291 for displaying an image, a gate pad region 292 for receiving gate signals, and a data pad region 293 for receiving data signals. The gate and data pad regions are disposed on a peripheral portion of the first substrate 210.

The first metal layer is patterned, and thus a plurality of gate lines 270 extends in a first direction on the first substrate 210 spaced by a predetermined distance with each other. A gate electrode 221 is branched from each of the gate lines 270, and a gate electrode pad 270a is formed on an end portion of each gate line 270. Therefore, the gate electrode pad 270a is formed on a peripheral portion of the pixel region 291 that is referred to as a gate pad region 292. As an exemplary embodiment, the gate electrode pad 270a is formed to have a surface area greater than the surface area of the gate electrode 221 and the gate line 270.

Subsequently, silicon nitride (SiNx) is deposited on a whole surface of the first substrate 210 through a plasma chemical vapor deposition (CVD) process, and thus a gate insulating layer 222 is formed on the gate lines 270, the gate electrodes 221 and the gate electrode pads 270a.

As shown in FIG. 10B, an amorphous silicon and an in-situ doped N+ amorphous silicon are sequentially deposited on the gate insulating layer 222 through the plasma CVD process, thereby to form a stacked layer of amorphous silicon and N+ amorphous silicon. Then, the stacked layer is patterned, and the semiconductor layer 223 and the ohmic contact layer 224 are formed on a portion of the gate insulating layer 222 corresponding to the gate electrode 221.

A second metal layer is deposited on the whole surface of the first substrate 210 on which the semiconductor layer 223 and the ohmic contact layer 224 are formed. The second metal layer comprises aluminum (Al), molybdenum (Mo), chrome (Cr), tantalum (Ta), titanium (Ti), copper (Cu) or tungsten (W). The second metal layer is patterned, and then a plurality of data lines 280 extends in a second direction perpendicular to the first direction on the gate insulating layer 222 spaced by a predetermined distance with each other. Then as shown in FIG. 4, a source electrode 225 branched from each of the data lines 280 and a drain electrode 226 facing the source electrode in the second direction are formed. Further, a data electrode pad 280a is formed on an end portion of each data line 280. Therefore, the data electrode pad 280a is formed on a peripheral portion of the pixel region 291 that is referred to as a data pad region 293. As an exemplary embodiment, the data electrode pad 280a is formed to have a surface area greater than the surface area of the data line 270.

Accordingly, a plurality of TFTs is formed on the pixel region 291 of the first substrate 210, and each of the TFTs includes the gate electrode 221, the semiconductor layer 223, the ohmic contact layer 224, the source electrode 225 and the drain electrode 226. The gate and data electrode pads 270a and 280a are formed on the gate pad region 292 and the data pad region 293, respectively.

Subsequently as shown in FIGS. 10C and 10D, a photoresistive material is deposited on the whole surface of the first substrate 210 with a predetermined thickness, so that the photoresist layer 231 is formed on the pixel region 291, the gate and data pad regions 292 and 293.

A first mask 700 having a first transparent region 710 and a first masking region 720 is disposed over the photoresist layer 231, and the photoresist layer 231 is selectively removed through a photo process using the first mask 700. Therefore, an organic or inorganic insulating layer 230 is formed in the pixel region 291 and a first protrusion member 251 is formed in the gate and data pad regions 292 and 293. The insulating layer 230 includes a contact hole 235 for exposing a portion of the drain electrode 226, and the first protrusion member 251 exposes a peripheral portion of the gate electrode pads 270a in the gate pad region 282 and a peripheral portion of the data electrode pads 280a in the data pad region 283.

A transparent conductive material such as ITO, IZO, etc., a metal such as aluminum-neodymium (AlNd), molybdenum-tungsten (MoW), or reflective material, etc., is deposited on the organic or inorganic insulating layer 230 and the first protrusion members 251, so that a transparent conductive layer or a metal layer is formed. The transparent conductive layer or the metal layer is patterned to form a pixel electrode (not shown) and a first conductive coating layer (not shown). Otherwise, the pixel electrode and the first conductive coating layer may be formed into a stacked structure by patterning a sacked layer including the transparent conductive layer and the metal layer. Therefore, the TFT substrate 200 shown in FIG. 5 is formed.

Then, The TFT substrate 200 is oppositely combined with a color filter substrate 300 spaced by a predetermined distance for injecting a liquid crystal into therebetween. That is, the TFT substrate 200, the color filter substrate 300 facing the TFT substrate 200, and the liquid crystal layer interposed between the TFT substrate and the color filter substrate constitute the liquid crystal display apparatus 100 shown in FIG. 3.

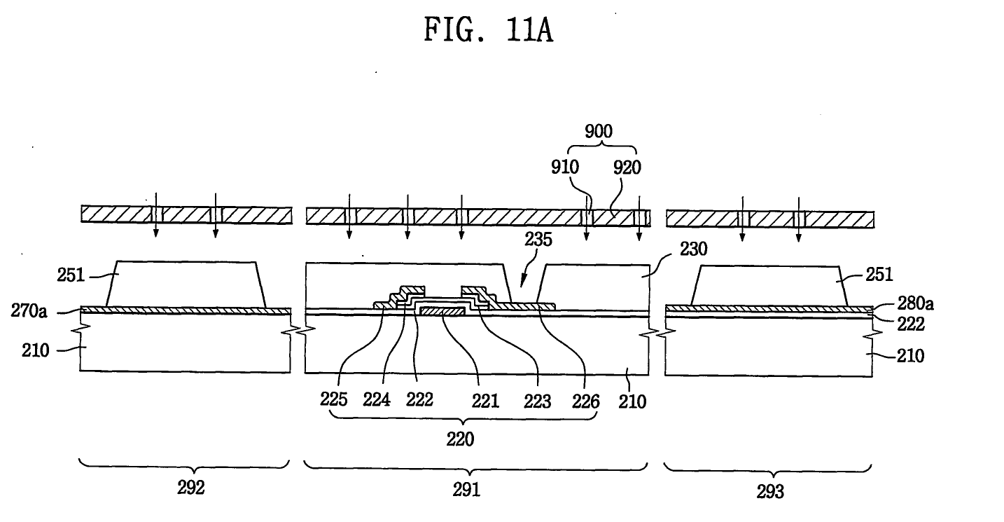

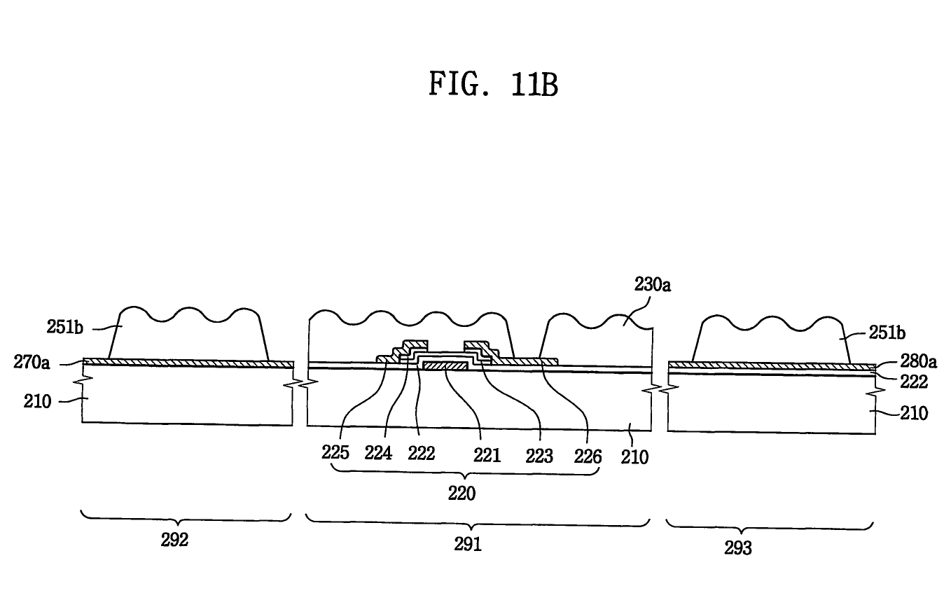

FIGS. 11A and 11B are cross-sectional views illustrating a method of manufacturing a TFT substrate according to another embodiment of the present invention.

Referring to FIGS. 11A and 11B, the photoresist layer 231 is coated on the first substrate 210 in the same way as described on the photoresist layer shown in FIG. 10C. A second mask 800 having a second transparent region 810 and a second masking region 820 is positioned over the photoresist layer 231, and the photoresist layer 231 is selectively removed through a photo process using the second mask 800. Therefore, an insulating layer 230 is formed in the pixel region 291 and a plurality of second protrusion members 251a is formed in the gate and data pad regions 292 and 293 with a uniform height. The organic or inorganic insulating layer 230 includes a contact hole 235 for exposing a portion of the drain electrode 226, and the second protrusion members 251a expose a peripheral portion of the gate electrode pads 270a in the gate pad region 282 and a peripheral portion of the data electrode pads 280a in the data pad region 283.

A plurality of the second masking regions 820 is positioned over the gate electrode pad 270a or the data electrode pad 280a with a predetermined surface area. The second transparent region 810 separates every second masking region 820 from each other. Therefore, the second protrusion members 251a are formed into projections spaced apart by a predetermined distance corresponding to the second masking region 820.

Since the photoresist layer 231 below the second transparent region 810 is removed during the photo process, a portion of the gate and data electrode pads 270a and 280a between the projections of the second protrusion member 251a is exposed.

The transparent conductive material such as ITO, IZO, etc., the metal such as aluminum-neodymium (AlNd), molybdenum-tungsten (MoW), or reflective material, etc. is deposited on the organic or inorganic insulating layer 230 and the second protrusion members 251a, and thus the transparent conductive layer or the metal layer is formed. The transparent conductive layer or the metal layer is patterned to form a pixel electrode (not shown) and a first conductive coating layer (not shown). A stacked layer including the transparent conductive layer and the metal layer may be patterned to form a stacked structure having the pixel electrode and the first conductive coating layer.

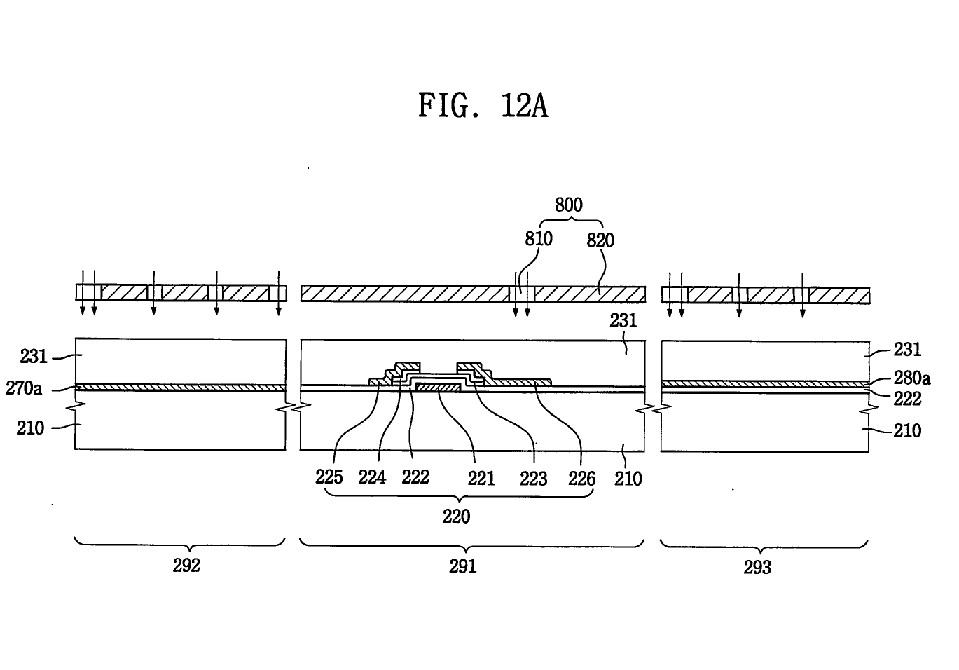

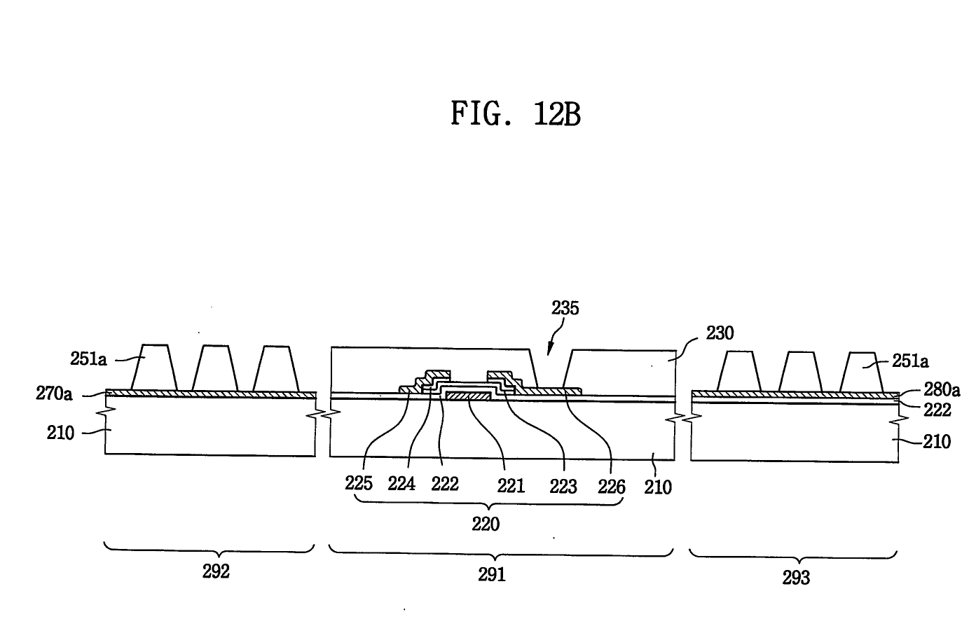

FIGS. 12A and 12B are cross-sectional views illustrating a method of manufacturing a TFT substrate according to a further embodiment of the present invention.

Referring to FIGS. 12A and 12B, the organic or inorganic insulating layer 230 and the first protrusion members 251 are formed on the first substrate 210, as shown in FIG. 10D. That is, the insulating layer 230 includes the contact hole 235 in the pixel region 291, and the first protrusion members 251 are disposed in the gate and data pad regions 292 and 293 of the first substrate 210. Then, a third mask 900 having a third transparent region 910 and a third masking region 920 is positioned over the first substrate 210, and the insulating layer 230 and the first protrusion members 251 are patterned by using the third mask 900 such that an embossing pattern is formed on an upper surface of the insulating layer 230 and the first protrusion members 251. That is, a plurality of third protrusion members 251b are formed in the gate and data pad regions 292 and 293 on the first substrate 210. The embossing pattern may be only disposed on the upper surface of the first protrusion members 251 except for the upper surface of the insulating layer 230, as would be known to a person having ordinary skill in the art.

A transparent conductive layer or a metal layer is deposited on the insulating layer 230 and the third protrusion members 251b. The transparent conductive layer comprises ITO or IZO, and the metal comprises aluminum-neodymium (AlNd) or molybdenum-tungsten (MoW). Then, The transparent conductive layer or the metal layer is patterned to form a pixel electrode (not shown) in the pixel region 291 and a third conductive coating layer (not shown) on the third protrusion member 251b. A sacked layer including the transparent conductive layer and the metal layer is patterned to form a stacked structure including the pixel electrode and the first conductive coating layer.

While the present invention discloses that the contact hole and the third protrusion members are formerly formed and the embossing pattern is latterly formed, the embossing pattern may be formerly formed on the photoresist layer, and then the contact hole and the third protrusion members are latterly formed, as would be known to a person having ordinary skill in the art.

### INDUSTRIAL APPLICABILITY

As mentioned above, an elastic conductive bump is formed in the gate and data pad regions of a TFT substrate of the LCD apparatus or other display applications such as Electro luminescent Display, PDP or others, and the driving IC is mounted on the elastic conductive bump through an intermediary of a non-conductive resin interposed between the conductive bump and the driving IC.

The non-conductive resin adheres the driving IC to the conductive bump to ensure the electrical connection between the driving IC and the conductive bump.

A contraction force of the non-conductive resin due to a hardening thereof after the thermo-compression process can improve the adhering force between the driving IC and the conductive bump.

In addition, the conductive bump is comprised of an elastic material and is compressively bonded to the driving IC, and as a result, the restoring of the first conductive bump can compensate for an increased distance between the gate electrode pad and the driving IC due to the thermal expansion of the non-conductive resin or other factors. Therefore, the electrical connection between the gate electrode pad and the driving IC can be sufficiently ensured.

Although the exemplary embodiments of the present invention have been described, it is understood that the present invention should not be limited to these exemplary embodiments but various changes and modifications can be made by one ordinary skilled in the art within the scope of the present invention as hereinafter claimed.

1. A thin film transistor substrate comprising:
a plurality of electrode pads disposed on end portions of gate and data lines arranged on a substrate; and
a conductive bump including a protrusion member disposed on the electrode pad with a predetermined thickness and a conductive coating layer disposed on the protrusion member to be electrically connected to the electrode pad, the conductive bump being electrically connected to a driving integrated circuit (IC) that applies a predetermined signal to the electrode pad by using a non-conductive resin.

2. The thin film transistor substrate of claim 1, wherein the protrusion member is disposed on the electrode pad such that a peripheral portion of the electrode pad is exposed.

3. The thin film transistor substrate of claim 2, wherein the protrusion member comprises an embossing pattern on an upper surface thereof.

4. The thin film transistor substrate of claim 1, wherein the protrusion member comprises a plurality of projections spaced apart by a predetermined distance, a portion of the electrode pad being exposed through a space between the projections.

5. A method of manufacturing a thin film transistor substrate, the method comprising:
forming a gate line, a data line and a plurality of electrode pads disposed on end portions of the gate and data lines; and
forming a conductive bump including a protrusion member disposed on the electrode pads to have a predetermined thickness and a conductive coating layer disposed on the protrusion member to be electrically connected to the electrode pad, the conductive bump electrically connected to a driving IC that applies a predetermined signal to the electrode pad by using a non-conductive resin.

6. The method of claim 5, wherein the conductive bump is formed by:
forming a photoresist organic layer on the electrode pad;
patterning the photoresist organic layer to form a protrusion member on the electrode pad;
forming a conductive layer covering the protrusion member; and
patterning the conductive layer to form a conductive coating layer on the protrusion member, the conductive coating layer being electrically connected to the electrode pads.

7. A liquid crystal display (LCD) apparatus including a pixel region having a plurality of thin film transistors (TFT) and conductive lines connected to the thin film transistors, and including a pad region having a plurality of electrode pads, the LCD apparatus comprising:
an LCD panel including a TFT substrate, a color filter substrate corresponding to the TFT substrate, and a liquid crystal layer interposed between the TFT substrate and the color filter substrate, the TFT substrate including a protrusion member disposed on the electrode pad and a conductive bump disposed on the protrusion member, the conductive bump having a conductive coating layer that is electrically connected to the electrode pad;
a driving integrated circuit (IC) electrically connected to the conductive bump to apply a predetermined signal to the electrode pad; and
an adhering member disposed between the conductive bump and the driving IC, the adhering member adhering the driving IC to the conductive bump to ensure an electrical connection between the conductive bump and the driving IC.

8. The liquid crystal display apparatus of claim 7, wherein the protrusion member comprises an elastic organic material so that the conductive bump is compressed by a distance when the driving IC is pressed down and is restored corresponding to the distance when the driving IC is released, thereby maintaining an electrical connection between the conductive bump and the driving IC.

9. The liquid crystal display apparatus of claim 8, wherein the protrusion member is disposed on the electrode pad such that a peripheral portion of the electrode pad is exposed.

10. The liquid crystal display apparatus of claim 9, wherein the protrusion member comprises an embossed pattern on an upper surface thereof.

11. The liquid crystal display apparatus of claim 8, wherein the protrusion member comprises a plurality of projections spaced apart by a predetermined distance, a portion of the electrode pad being exposed through a space between the projections.

12. The liquid crystal display apparatus of claim 7, wherein the adhering member comprises a non-conductive resin that is softened during a thermal compression process on the driving IC and has gradually hardened from the time when the thermal compression process is completed, so that the driving IC is adhered to the conductive bump by a contraction of the non-conductive resin due to a hardening thereof.

13. A method of manufacturing a liquid crystal display apparatus including a pixel region having a plurality of thin film transistors (TFT) and conductive lines connected to the thin film transistors, and including a pad region having a plurality of electrode pads, the LCD apparatus comprising:
forming a TFT substrate including a protrusion member formed on the electrode pad and a conductive bump formed on the protrusion member, the conductive bump having a conductive coating layer that is electrically connected to the electrode pad;
forming a color filter substrate oppositely combined with the TFT substrate;
forming a liquid crystal layer between the TFT substrate and the color filter substrate; and
connecting a driving integrated circuit (IC) to the conductive bump electrically by using an adhering member, the driving IC applying a predetermined signal to the electrode pad.

14. The method of claim 13, the TFT substrate is formed by:
forming a photoresist organic layer in the pixel and pad regions;
patterning the photoresist organic layer to form an insulating layer in the pixel region and a protrusion member in the pad region, the insulating layer protecting the plurality of TFTs and the conductive lines, the protrusion member being formed on the electrode pad;
forming a conductive layer over the insulating layer and the protrusion member; and
patterning the conductive layer to form a pixel electrode on the insulating layer and a conductive coating layer on the protrusion member electrically connected to the electrode pad.

15. The method of claim 14, wherein the conductive layer comprises indium tin oxide (ITO) or indium zinc oxide (IZO).

16. The method of claim 14, wherein the conductive layer comprises metal.

17. The method of claim 14, wherein the conductive layer comprises a lo stacked layer having first and second layers, the first layer including ITO or IZO and the second layer including metal.

18. The method of claim 13, wherein the adhering member comprises a non-conductive resin that is softened during a thermal compression process on the driving IC and has gradually hardened from the time when the thermal compression process is completed, so that the driving IC is adhered to the conductive bump by a contraction of the non-conductive resin due to a hardening thereof.
